(19) United States
(12) Patent Application Publication
(10) Pub. No.: US 2011/0285123 A1
(43) Pub. Date: Nov. 24, 2011

(54) Pre-Printed Sticky Notes and Methods of Use

(76) Inventor: Cynthia Sue Hasko Wittke, Wausau, WI (US)

(21) Appl. No.: 13/198,523

(22) Filed: Aug. 4, 2011

Related U.S. Application Data
(63) Continuation-in-part of application No. 12/643,840, filed on Dec. 21, 2009, now abandoned.
Application No. 12/643,840 is a continuation of application No. 11/648,736, filed on Jan. 3, 2007, now abandoned.
(60) Provisional application No. 60/761,141, filed on Jan. 23, 2006.

(51) Int. Cl. B42D 15/00

(52) U.S. Cl. 283/63.1

(57) ABSTRACT

Pre-printed sticky notes that are pre-printed with one or more messages, thereby enabling a user of the invention to decorate a home, office, or other structure or object with the sticky notes to convey a message or expression without writing the message herself. Because the notes are all printed with messages, a user of the invention can easily and rapidly place one, some or many such notes on the wall, object, or any other surface so as to decorate it, thereby sending a “loud” message or expression to the intended recipient. The user can also use a single sticky note, or larger amounts of the pre-printed sticky notes, to convey a message in a greeting card, letter, scrapbook, photo album, etc.

### CROSS REFERENCE TO RELATED APPLICATIONS

This application is a continuation-in-part of U.S. patent application Ser. No. 12/643,840 filed on Dec. 21, 2009, which in turn is a continuation of U.S. patent application Ser. No. 11/648,736 filed on Jan. 3, 2007, which in turn is a non-provisional of U.S. Provisional Patent Application No. 60/761,141 filed on Jan. 23, 2006, the entireties of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention is directed toward packs, pads, rolls, or sheets of sticky notes that are pre-printed with one or more messages, thereby enabling a user of the invention to decorate a home, office, or other structure or object with the sticky notes to convey a message or expression, such as “Happy Birthday”, “Congratulations,” “Get Well,” “Happy Holidays,” “Thank You,” etc, pictures, numbers, symbols, etc. without writing the message herself. The sticky notes are compiled in the traditional fashion, with each note having a thin portion near the top, side or sides, center or bottom, or all over if on a roll or sheet, which has a removable, semi-sticky glue which allows it to stick to a wall or other object (or to the note directly behind it in the pack), but also allows a user to remove it without removing paint from the wall or leaving behind any undesirable glue residue. Because the notes are all printed with messages, a user of the invention can easily and rapidly place one, some or many such notes on the wall, object, or any other surface so as to decorate it, thereby sending a “loud” message or expression to the intended recipient. The user can also use a single sticky note, or larger amounts of the pre-printed sticky notes, to convey a message in a greeting card, letter, scrapbook, photo album, etc.

The history of sticky notes goes back to 1974, when 3M engineer Art Fry invented the Post-It® Note. Fry combined an adhesive invented years earlier by another engineer at 3M with a standard piece of paper, in a shape and size useful for being a note. The adhesive, invented by a 3M chemist named Spencer Silver was a mixture of some simple organic molecules which, when combined in a manner which remains a trade secret, produced an adhesive described as “inherently tacky elastomeric copolymer microspheres”, which, in plain English, means that the adhesive had an irregular surface texture with peaks and valleys, somewhat resembling the surface of a basketball. While the peaks stuck to whatever they came into contact with, the valleys prevented a complete seal, allowing it to stick fairly well, but not very strongly, thereby allowing for it to be removed. Fry then added a primer to the paper which caused the adhesive to stick more firmly to the paper than to the wall or other object to which the note was affixed, thereby creating the commercially successful Post-It® Note that has become as much a mainstay of the average office as staplers and paperclips.

Once 3M's patent on the Post-It® Note expired, numerous competitors began producing similar products, to the point where presently there are a number of companies producing sticky notes of all shapes, colors, and sizes. These products, however, still require a user of them to write a message on the sticky note before using the note to convey a message. For example, in a patent office setting, it would be convenient for a person reviewing a patent application to be able to take sticky notes with messages such a “103 problem”, “Re-write this section”, “Are you sure there is no prior art on this aspect?”, from a stack of sticky notes and affix the proper note on the application. As another example, a secretary sorting mail away from the mailboxes in an office could affix sticky notes with various employees' names, and messages such as “Greg”, “bill”, “Important!”, or “Payment” on each piece of mail.

The inventor has also determined that placing sticky notes with pre-printed messages on a mirror or wall is an effective, and easily removed, method of sending a message. Since prior to this invention, a user needs to write a message on each sticky note, it would be very time consuming for a user to prepare enough sticky notes to use the sticky notes in large quantities to loudly proclaim a message, expression, or celebration, or to decorate (albeit probably temporarily) a room, office, etc. Because the sticky notes lend themselves so readily to being stuck on a wall quickly and removably, the inventor has discovered that a large number of these sticky notes placed on a wall or mirror makes a very effective means of conveying a message, expression or celebration.

Thus there has existed a long-felt need for packs of sticky notes with pre-printed messages on them, which can be used for both quickly attaching a message to an item and decorating a wall or other structure with the desired message or expression.

The prior art has a number of inventions relating to sticky notes in various configurations. Obviously, the sticky note itself is well known in the art, but a substantial number of variations on that basic theme have been proposed. For example, U.S. Pat. No. 5,332,265 to Groess, et al., teaches an advertising assembly which uses a plurality of advertising indicia arranged on an insert or as a trade show handout. U.S. Pat. No. 6,526,906 to Bidanset, et al., and US Patent Application No. 2003/0178840 to Bidanset, et al, teach a page marking device with removable tabs which can be affixed to an advertisement for a certain type of gift. US Patent Application No. 2005/0110267 to Stewart, et al., provides a bookmark with a plurality of self-stick notes attached thereto.

There also exist a number of inventions dealing with methods of making various types of sticky notes. For example, U.S. Pat. No. 6,268,032 to Mertens, et al., which describes a web sheet of material, whereas U.S. Pat. No. 6,773,539 to Mertens, et al., provides a method for cutting sticky notes from a roll of starting material. U.S. Pat. No. 5,782,494 to Crandall allows a user of a basic personal computer to make his or her own sticky notes.

Another invention is described by U.S. Pat. No. 6,379,764 to Pusateri, et al., which teaches a method and apparatus for securing a sticky note onto an advertisement. Finally, U.S. Pat. No. 5,705,244 to Lee covers a composite note pad assembly.

While these inventions all provide improvements to the existing technology, none of them teach the idea of mass-produced sticky notes with a certain message, expression or celebration, nor do these patents and applications describe a manner of using the message-containing sticky notes for use in efficiently designating or categorizing items by the individual messages contained on the pad of sticky notes. Additionally, there is no hint of the use of any of these sticky notes and close approximations thereof for temporarily decorating a mirror or wall, object, scrapbook, photo album, etc. as a means of decorating, celebrating or communicating.

The idea of a sticky note with pre-printed indicia is also known. For example, 3M offers a number of sticky notes with pre-printed logos. However, the examples found in the prior art search date from after the date of applicant's provisional patent, and also supply only identifying information such as a name or “From the Desk of ______”. The prior art does not disclose a sticky note with a pre-printed message—as opposed to identifying information—which would allow a user to quickly affix a sticky note with the proper message to an item without personally writing a message on the sticky note. The prior art also does not teach a sticky note with a message proper for decorating a wall or other structure with many such sticky notes, nor do the sellers of any of the pre-printed sticky notes suggest the use of their sticky notes in mass quantities as a decorative means to send a message, expression or celebration. Furthermore, the prior art does not teach of a sticky note wherein it is intended that the user not write on the sticky note, but rather rely solely on the pre-printed message as the means of communication.

### SUMMARY OF THE INVENTION

The current invention provides just such a solution by having a pre-printed pack of sticky notes with one or more themes/messages printed on each sticky note, thereby enabling a user of the invention to decorate a home, office, or other structure with the sticky notes to convey a message or expression, such as “Happy Birthday”, “Congratulations”, “Get Well,” “Thank You” & “Happy Holidays,” etc. The sticky notes are compiled in the traditional fashion, with each note having a thin portion near the top, side, center or bottom or all over if on a roll or sheet, which has a removable, semi-sticky glue which allows it to stick to a wall or other object, (or to the note directly behind it in the pack), but also allows a user to remove it without removing paint from the wall or other object or leaving behind any undesirable glue residue. Because the sticky notes are easily removed from the pack, and are pre-printed with the desired message, they are easy to place in large or small quantities on a mirror or wall (or even a floor, ceiling, car, seat, scrapbook, photo album or other hard or soft surface) in a decorative manner to send a forceful (bold) message. Thus, the inventor has invented not only a new product but also a new way of using sticky notes to send a message in a manner not seen to date.

It is a principal object of the invention to provide a sticky note with a pre-printed message, expression or celebration.

It is another object of the invention to provide packs, pads or sheets, of sticky notes with pre-printed messages on them where the packs can be of different designs, shapes, sizes, scents and colors, and there can be a wide variety of messages.

It is an additional object of the invention that the packs of sticky notes can have either one message in one or more colors and/or designs, and a variety of “themed” messages in one or more colors and/or designs.

It is a further object of the invention that the sticky notes can be quickly and easily removed from the pack and adhered to a wall, desk, table, chair, mirror, seat, car, scrapbook, card, letter or other hard or soft object including people and pets.

It is also an object of this invention that a user of the invention can decorate a desired surface with the notes quickly, easily, and in an eye-pleasing manner, such that the notes can be easily and cleanly removed once the user of the invention wishes to remove the notes.

It is a further object of this invention that the use of pre-printed sticky notes can save a user time in sending a frequently-sent message, and allows him/her to use large or small quantities of sticky notes to send a bold message by affixing the large or small quantities of sticky notes to the desired surface.

It is yet another object of this invention to provide a pre-printed sticky note that is not written on by users.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### DETAILED DESCRIPTION OF THE INVENTION

The invention involves pre-printing sticky notes and assembling them into packs, pads, rolls or sheets. To produce the invention, it is necessary to print the desired message on a piece of paper of the desired color and in the desired size. A primer is laid on the paper which is intended to be “sticky”, after which the adhesive is laid over the primer. Groups of sticky notes are then compiled into stacks, sheets, rolls, or pads.

The advantages of this invention are detailed above in the Summary of the Invention. Basically, the invention consists of a pre-printed pack of sticky notes with one more themes printed on each sticky note, thereby enabling a user of the invention to decorate a home, office, or other structure or object, person or animal with the sticky notes to convey a message or expression, such as “Happy Birthday”, “Congratulations”, “Get Well,” “Thank You,” “Happy Holidays,” etc without having to personally write on the sticky note. The sticky notes are compiled in the traditional fashion, with each note having a thin portion near the top, side or sides, center or bottom or all over if on a roll or sheet, which has a removable, semi-sticky glue which allows it to stick to a wall or object (or to the note directly behind it in the pack), but also allows a user to remove it without removing paint from the wall or object or leaving behind any undesirable glue residue or to most surfaces. Because the sticky notes are easily removed from the pack, and are pre-printed with the desired message, they are easily placed in large or small quantities on a mirror or wall (or even a floor, ceiling, car seat, scrapbook or other hard or soft surface) in a decorative manner to send a forceful (bold) message. Thus, the inventor has invented not only a new product but also a new way of using sticky notes to send a message in a manner not seen to date.

The printed material (message) on the face of the sticky notes can range to include words, expressions, pictures, famous sayings, quotes, verses, common phrases, numbers, letters of exclamations, celebration, inspiration, encouragement or other statements printed on each sheet. The sticky notes can also be customized in terms of having a texture added to the surface, being made in a specific color, or with an item of artwork ordered or created by the customer who orders the sticky notes. There are two main purposes of the invention. First, there are frequently sent messages, whereby a user of the invention would merely need to affix the proper sticky note in the proper location. For example, a professional reviewing the work of an assistant could slap sticky notes with sayings such as “Yes”, “No”, “See Me”, “Send to Typing”, or “Greg” on the file rather then writing it by hand. While the savings in time on an individual case would be small, the cumulative savings of time over the course of a year would be substantial. The second and preferred iteration of the invention would be to use large or small quantities of sticky notes with messages pre-printed on them to decorate the home, office, school, transportation, etc. as a means of expression, communication, celebration, encouragement, education or entertainment.

It is also envisioned that a variety of colors, shapes, scents, designs, embellishments (glitter, glow in the dark, etc.), and messages could be incorporated into the notes such that a user of the invention could create a wide range of responses. Among the locations at which these notes could be used are homes, businesses, offices, classrooms, lockers, hospital rooms, wedding locations, bridal and baby showers, scrapbooks (photo albums), greeting cards, letters, parties & events of all sorts, in cars, on bicycles, on people, pets, etc.

There are several specific uses of the notes that are contemplated in addition to the uses described heretofore. For example, a travel pack of notes could describe or have pictures of objects commonly seen while riding in a car or bus, such as stop signs, railroad crossing signals, trains, motorcycles, etc., and could be used to educate or entertain children (as making a game of it) during the trip. A color pack with the color and name printed on it could allow a parent to teach a child about colors, allowing the child to find an object of a specific color and stick on the appropriate sticky note to that object (and learn to spell the name of the color at the same time).

Other educational packs of notes could include names of household objects, where a sheet could be given to the child and he/she must stick the sheet on the correct item. A multi-lingual household pack could have the names of household objects or everyday phrases in various languages.

Another specific use would be a pack of 365 (plus extra for leap years) sticky notes where each successive sticky note in the pack of 365 sticky notes has an ascending number to signify the day of the year a user of the invention is currently living. This way, a user of the invention could keep the sticky note that corresponded to a particularly important day. An additional option would be to have each pack of 365 sticky notes be identified as relating to a particular year of a person's life—such as year 20, and where each pack of 365 sticky notes would have a first sticky note, and the first sticky note would be numbered the day of a person's life corresponding to the particular year of a person's life In the example of a pack of sticky notes for a person is his/her 20th year of life, a person celebrating their 20th birthday would be living his or her 7305th day of life (adding in the leap year days). The number on the first page of the pack would be 7306, the second page=7307, third page 7308, etc. It would be somewhat like a Calendar of the year but would not reference an actual date. The user could stick the sticky note to anything for the day as a reminder of something to do or as a remembrance of the day and place it in a card, scrapbook, photo album, mirror, etc.

A set of notes for a wedding could include color-coded seating designations. Notes with various messages could also be used for ice-breakers and introductions: A person planning a party could give the attendees various pre-printed sticky notes which are either color coded or state the interests, background, etc. of the various attendees. These sticky notes could be a great way to “break the ice” and make introductions.

One of the novel features of the current invention is the relation to the printed material to an object or surface where the message is placed. For example, the pre-printed sticky notes can include common household objects written in a foreign language. Users can then educate themselves or others by placing and repositioning the pre-printed sticky notes on the objects indicated thereon. As another example, numbers and mathematical signs can be placed on a surface and rearranged to create a correct mathematical equation, such as 2+3=5.

In a selected embodiment of the current invention, each individual sticky note in a pack of sticky notes is flocked, thereby creating a “velvet” style texture. Preferably, the entire front surface of the sticky note is flocked. Flock material (fibers) is adhered to the base material (the sticky note) with an adhesive. The adhesive is affixed to the sticky note by printing, coating, spraying, or other means well known in the art. Preferably, the flock is applied in a specially designed flocking machine that creates an electrostatic charge to orient fibers of the flock such that they vertically align themselves relative to the sticky note when they are attached to the adhesive layer. To increase the effects of the electrostatic charge, an electrostatic coating is applied to the fibers. Alternatively, the fibers are deposited directly (without an electrostatic charge) on the adhesive layer for a more random, flatter appearance. The flock fibers can be manufactured from materials such as rayon, nylon, acrylic, polyester, and/or cotton in a wide variety of colors. The fibers are preferably 1.5 to 100 deniers with a length ranging between 0.20 inches and 0.250 inches.

In addition to or in the alternative, glitter is applied to the base material sticky note. Glitter, made from polyester or aluminum, is obtained in either particle form, ranging from 0.002 inches in diameter up to 0.250 inches in diameter, or fiber form, ranging from 0.035 inches to 0.125 inches in length and 0.0040 inches to 0.0125 inches in diameter. A mixture of 10% to 40% concentrated glitter in a solvent, such as a liquefied adhesive, is screen printed onto the sticky note, preferably covering a majority and even more preferably all of the surface of one side of the sticky note, to a thickness of between 0.0005 to 0.0030 inches. Alternatively, the surface of the sticky note has a coating applied thereto, and then glitter is applied to the coated surface by sprinkling, blowing, pressing, or like methods. In a selected embodiment, the entire front surface of the sticky note is covered with glitter to a concentration of at least 10%.

The use of flocking and/or glittering the surface of the sticky note reduces, if not eliminates, a user's ability to write on the sticky note itself. Vertically oriented flock and highly concentrated glitter further reduces the user's ability to write custom words and/or pictures on the sticky note due to the rough texture and/or dark coloring of the surface of the sticky note.

Phosphorescent ink, otherwise known as glow in the dark ink, may be used for pre-printed messages and/or as a part of the solvent used for the flocking/glitter. The phosphorescent ink is excited by sunlight, artificial light, or electrical charge to produce light, whereby after being “charged,” the phosphorescent ink emits light for a period of time. Heavier deposits of phosphorescent particles or more concentrated phosphorescent solutions result in an extended period of light emission. Typical concentrations of phosphorescents are 10% to 40% concentration in a solvent, with the particular solvent chosen based upon the surface to which the phosphorescent ink is to be applied. The ink may be printed, coated, or sprayed onto the sticky note with a preferred thickness of 0.001 inches to 0.080 inches, though more preferably between 0.039 inches and 0.079 inches, to provide the desired degree and period of light emission from the phosphorescent ink.

Heavier weight paper is used as the base for the sticky note according to selected embodiments of the current disclosure. Preferably, the paper has a weight of between 40 lb. and 80 lb., though more preferably the paper has a weight of 60 lb. This provides a sufficiently strong surface to support the flocking, glitter, specialized inks, stronger adhesives, and three-dimensional surfaces. In fact, multicolored or even holographic paper can be used. The surface of the paper may be satin coated to give it a glossy effect. The satin coat may be applied before or after other layers depending on the effect that is desired.

Other specialized inks are optionally used as well or instead of the phosphorescent ink. Depending upon the composition and color of the paper used as the base material for the sticky note, appropriate inks must be used to create the requisite contrast to enable someone to view the pre-printed sticky note from a distance.

The heavier weight paper, while providing a strong support surface, also allows for a stronger adhesive to be used. This re-sealable, removable adhesive should withstand high and low temperatures as well as offer resistance to UV rays and chemical interactions. It must have a low peel strength with a high cohesion. In fact, this adhesive should be a high performance acrylic adhesive with a minimum application temperature of 50° F. and a service temperature ranging from −15° F. to 200° F. For example, the RC-1 adhesive from Wausau Coated Products is such an adhesive that meets these requirements. Such a strong adhesive can and should be used because of the heavier weight paper that is used for the sticky notes; the paper of the sticky note is less likely to break under the increased forces required to remove the sticky note from a surface, and the stronger adhesive will support the heavier weight of the sticky note (with flocking, glitter, etc.) and maintain its attachment to the surface for a longer period of time.

Three-dimensional shapes may also be incorporated into the pre-printed sticky notes. The heavier paper used by the current invention allows three-dimensional shapes, such as pleats and folds, to be incorporated into stacks of pre-printed sticky notes. In an alternative embodiment, each sticky note is scored to enable the user to quickly and effectively create a three-dimensional shape from the sticky note after the sticky note has been removed from the pack.

One of the important aspects of the current invention is that users do not write on the sticky note themselves. The embellishments on the sticky note, such as flocking, glitter, glow in the dark inks, and pleats, make it difficult if not impossible for a user to write their own message on the sticky note. Therefore, the message itself must be printed on the sticky note for the user. This goes against prior art teachings, which specifically allowed for and enabled users to write messages on the sticky notes. It is also important to understand that the above embellishments can, and often are used in combination. For example, the front surface of the sticky note may be both flocked and glittered, with phosphorescent ink used to create the pre-printed message.

Appropriate font sizes must be used to ensure that the message pre-printed on the sticky note is easily viewed. The font sizes are preferably at least 20 points, and more preferably 24 points or greater. Font sizes of 12 points or less should be avoided, as they are not viewable from a distance and may not show up properly due to the three-dimensional surface of the sticky note.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device for sending messages or expressions to people using repositionable and reusable sticky notes, comprising:
a plurality of sticky notes which has printed on each a pre-printed message, where the plurality of stick notes are compiled into a pack of sticky notes,
where each sticky note comprises a piece of paper with semi-sticky glue covering the entire back of the sticky note with the exception of a thin border on the top, bottom, and sides of the sticky note,
where the paper has a paper weight of 40 lb. or more,
where the semi-sticky glue is a re-sealable, removable high performance acrylic adhesive with a minimum application temperature of 50° F. and a service temperature range of −15° F. to 200° F.

2. The device of claim 1, wherein the paper weight is 60 lb. or more.

3. The device of claim 1, wherein each sticky note further comprises flocking, wherein the entire front surface of the sticky note is covered with flock.

4. The device of claim 1, wherein each sticky note further comprises glitter, wherein the entire front surface of the sticky note is covered with at least a 10% concentration of glitter.

5. The device of claim 1, wherein each sticky note further comprises flocking and glitter, wherein the entire front surface of the sticky note is covered with flock and at least a 10% concentration of glitter.

6. The device of claim 1, wherein each sticky note further comprises phosphorescent ink, where the phosphorescent ink is used to create the pre-printed message.

7. The device of claim 1, wherein the pre-printed message has a font size of at least 20 points.

8. The device of claim 1, wherein the pre-printed message has a font size of at least 24 points.

9. The device of claim 1, wherein each sticky note is pleated.

10. A device for sending messages or expressions to people using repositionable and reusable sticky notes, comprising:
a plurality of sticky notes which has printed on each a pre-printed message, where the plurality of stick notes are compiled into a pack of sticky notes,
where each sticky note comprises a piece of paper with semi-sticky glue covering the entire back of the sticky note with the exception of a thin border on the top, bottom, and sides of the sticky note,
where the paper has a paper weight of 60 lb. or more,
where the pre-printed message has a font size of at least 24 points,
where the semi-sticky glue is a re-sealable, removable high performance acrylic adhesive with a minimum application temperature of 50° F. and a service temperature range of −15° F. to 200° F.

11. The device of claim 10, wherein each sticky note further comprises flocking, wherein the entire front surface of the sticky note is covered with flock.

12. The device of claim 10, wherein each sticky note further comprises glitter, wherein the entire front surface of the sticky note is covered with at least a 10% concentration of glitter.

13. The device of claim 10, wherein each sticky note further comprises flocking and glitter, wherein the entire front surface of the sticky note is covered with flock and at least a 10% concentration of glitter.

14. The device of claim 10, wherein each sticky note further comprises phosphorescent ink, where the phosphorescent ink is used to create the pre-printed message.

15. The device of claim 10, wherein each sticky note is pleated.

16. A device for sending messages or expressions to people using repositionable and reusable sticky notes, comprising:
a plurality of sticky notes which has printed on each a pre-printed message, where the plurality of stick notes are compiled into a pack of sticky notes,
where each sticky note comprises a piece of paper with semi-sticky glue covering the entire back of the sticky note with the exception of a thin border on the top, bottom, and sides of the sticky note,
where the paper has a paper weight of 40 lb. or more,
where the pre-printed message has a font size of at least 24 points,
where each sticky note is pleated.

17. The device of claim 16, wherein each sticky note further comprises flocking, wherein the entire front surface of the sticky note is covered with flock.

18. The device of claim 16, wherein each sticky note further comprises glitter, wherein the entire front surface of the sticky note is covered with at least a 10% concentration of glitter.

19. The device of claim 16, wherein each sticky note further comprises flocking and glitter, wherein the entire front surface of the sticky note is covered with flock and at least a 10% concentration of glitter.

20. The device of claim 16, wherein each sticky note further comprises phosphorescent ink, where the phosphorescent ink is used to create the pre-printed message.
